(19) United States
(12) Patent Application Publication
(10) Pub. No.: US 2026/0188117 A1
(43) Pub. Date: Jul. 2, 2026

(54) INTEGRATED DIGITAL STATE MONITOR

(71) Applicant: INTEGRITY Security Services LLC, Ashburn, VA (US)

(72) Inventors: Brian Romansky, Monroe, CT (US); Amit Kapoor, San Francisco, CA (US)

(21) Appl. No.: 19/438,997

(22) Filed: Jan. 2, 2026

Related U.S. Application Data
(60) Provisional application No. 63/741,327, filed on Jan. 2, 2025.

(51) Int. Cl. G08G 1/097; G08G 1/07

(52) U.S. Cl. CPC G08G 1/097; G08G 1/07

(57) ABSTRACT

A system for monitoring signal conflicts in a traffic management system, includes: an integrated digital state monitor (IDSM) including a processor and a memory, the memory including computer-readable instructions that, when executed by the processor, cause the IDSM to perform operations including: receiving, from a traffic controller, a direct traffic controller signal, the direct traffic control signal indicating a status of a signal head perceived by the traffic controller; receiving, from a roadside unit, an RSU signal received by the roadside unit and relayed to the conflict monitor, the RSU signal indicating a status of a signal head perceived by the roadside unit; comparing the direct traffic controller signal to the RSU signal; and in response to the direct traffic controller signal being in conflict with the RSU signal, instructing the roadside unit to cease broadcasting a RSU broadcast signal.

### CROSS-REFERENCE TO RELATED APPLICATIONS

This application claims the benefit of U.S. Provisional Application No. 63/741,327 filed on 2 Jan. 2025, which is hereby incorporated by reference in its entirety.

### FIELD OF THE INVENTION

This invention relates to systems, devices, computer applications, and methods for monitoring the state of signals, particularly conflicts between signals, directed to, for example, vehicular traffic.

### BACKGROUND

In the domain of traffic management, a conflict (or state) monitor is a dedicated device that, among other things, ensures that a traffic-control signal head (e.g., a traffic light) can never enter a prohibited state such as, for example, all lanes from all directions turning green simultaneously. These safety-critical devices serve in a supervisory role ensuring that even if a traffic management device fails for some reason, the safety risk is limited to a set of allowed “fail-safe” state(s).

Currently, the conventional traffic management devices at an intersection use two basic configurations. The first configuration employs a traffic controller, a conventional conflict monitor, and a traffic signal (e.g., traffic light), and uses no digital data signal. This configuration has a conventional conflict monitor for safety, but there is no roadside unit (RSU), and the devices do not process any digital data related to the traffic signal. In this first configuration, the conflict monitor is not actually comparing the commands from the traffic controller with the signal head status. The conflict monitor is making sure that the traffic controller does not command a signal state that is not allowed, such as all lanes green at the same time. This could happen if the signal controller has some sort of logical flaw or failure. Latency is generally not an issue in this configuration, and there is little threat of the conflict monitor acting as a malicious attack surface because it has no external connections.

The second configuration also employs a conventional traffic controller, a conventional traffic signal, and a conventional conflict monitor, and also includes an RSU to broadcast a signal with digital data related to the traffic signal. This second configuration is becoming very common as Vehicle-to-Everything (V2X) environments become widespread, and it is estimated that up to10% of intersections in the United States include an RSU that broadcasts a digital signal at the time of this writing. In this second configuration there is no active monitoring of the traffic-signal-related digital data broadcast by the RSU. This has the drawback of introducing a previously unknown type of problem or conflict where the digital data broadcast by the RSU may be inconsistent with the signal head state. For example, the RSU-broadcasted data may indicate that the traffic light (signal head) is green when the actual current state of the traffic light is red. With no active monitoring in this second configuration, there is no way for the current intersection systems to know whether such a problem or conflict exists. Note that in the second configuration, the conventional conflict monitor (as described in the first configuration) remains in place and continues to operate normally, however, the conventional conflict monitor does not have any capability to process or analyze the digital data.

Any conflict or inconsistency between the data being broadcast and the actual state of the signal head (for example, the state (e.g., color) of a traffic light) could lead to a dangerous situation. For example, any vehicles that are in autonomous driving mode could respond to the broadcast data, while drivers in traditional vehicles only see the visible signal head, resulting in a dangerous situation when the broadcast data and the visual signal are not the same.

Problematic conflicts or inconsistencies may be caused by many things. For one, a malicious actor may intentionally alter or damage the hardware and/or software of the RSU, (or other traffic management device), such that it does not accurately process and/or report the current state (e.g., red, yellow, or green) of the traffic light (or other signal head). For another, an unintended hardware or software malfunction, defect, or failure in the RSU or other traffic management device may similarly cause an error in detecting, processing, and/or reporting the current state (e.g., red, yellow, or green) of the traffic light or other signal head. Temporal conflicts or inconsistencies may occur when the latency or delay between the time that the traffic controller generates the information describing the current state of the traffic light and the time that the RSU transmits a message with that information is so long as to create a dangerous difference between the actual current state (e.g., red, yellow, or green) of the traffic light and the purported state of the traffic light as perceived by a V2X vehicle that receives the delayed message from the RSU. Like state conflicts/inconsistencies, excessive latency may be caused by an unintended system design flaw(s), by a malicious actor, by equipment failures, or the like.

Accordingly, it is desirable to provide improved systems, methods, products, and techniques for monitoring the state of traffic management systems, devices, and signals, especially systems that include a V2X device such as an RSU. Various embodiments described herein address the above-noted and other drawbacks associated with conventional systems and techniques for monitoring traffic management devices and signals, such as traffic light signals.

### SUMMARY

Various embodiments of an Integrated Digital State Monitor (IDSM) are described herein. In various implementations, the IDSM may be employed as part of a Controlled Intersection (CI) system that also typically includes a traffic signal (or other signal head), a traffic controller, a conventional conflict monitor, and an RSU. In various embodiments, the IDSM is not intended to replace the safety role of the conventional conflict monitor in making sure that the traffic controller does not command an invalid or unsafe condition—instead, the IDSM makes sure that the state information in the digital V2X broadcast signal and the state of the physical traffic signal are consistent. In some other embodiments, the IDSM may perform both the new functions described herein and the functions of the conventional conflict monitor, thus replacing the conventional conflict monitor.

The IDSM embodies a novel, improved state monitoring device that performs a supervisory role, and some embodiments integrate select conflict detection and alerting functions within existing components of a C) system to reduce the cost and complexity of deployment. While the term IDSM is used in this disclosure, it is noted that the concepts described herein may also be called an Integrated Digital Conflict Monitor (IDCM) even though embodiments may monitor various different kinds of states and are not limited solely to monitoring conflicts. The concepts described herein may be implemented or embodied in the form of devices (e.g., computing systems, computerized devices), processes (e.g., computer-implemented methods), and manufactures (e.g., computer readable media containing program instructions).

Embodiments of the disclosure include a system for monitoring signal conflicts in a traffic management system, including a conflict monitor. The IDSM includes a processor and a memory, the memory including computer-readable instructions that, when executed by the processor, cause the IDSM to perform operations including: receiving, from a traffic controller, a direct traffic controller signal, the direct traffic control signal indicating a status of a signal head perceived by the traffic controller; receiving, from a roadside unit, an RSU signal received by the roadside unit and relayed to the conflict monitor, the RSU signal indicating a status of a signal head perceived by the roadside unit; comparing the direct traffic controller signal to the RSU signal; and in response to the direct traffic controller signal being in conflict with the RSU signal, instructing the roadside unit to cease broadcasting a RSU broadcast signal.

In various implementations, the RSU broadcast signal is a signal phase and timing (SPaT) message.

In various implementations, the RSU signal is relayed to the IDSM from a radio receiver of the roadside unit.

Various implementations further comprise computer-readable instructions that, when executed by the processor, cause the conflict monitor, in response to the direct traffic controller signal being in conflict with the RSU signal, to send an alert to a traffic management center that is located remotely from the conflict monitor. The alert indicates that the direct traffic controller signal is in conflict with the RSU signal.

Various implementations further comprise an isolator between the IDSM and the roadside unit that prevents data from flowing from the IDSM to the roadside unit.

Various implementations further comprise an isolator between the IDSM and the traffic controller that prevents data from flowing from the IDSM to the traffic controller.

Various implementations further comprise computer-readable instructions that, when executed by the processor, cause the IDSM to receive a signal from a sensor, the sensor observing the actual status of the signal head, and compare the actual status of the signal head to the RSU signal.

In various implementations, the sensor is a camera capturing the actual status of the signal head.

Embodiments of the disclosure include a method for monitoring signal conflicts in a traffic management system, the method including: receiving, by a IDSM from a traffic controller, a direct traffic controller signal, the direct traffic control signal indicating a status of a signal head perceived by the traffic controller; receiving, by the IDSM from a roadside unit, an RSU signal received by the roadside unit and relayed to the conflict monitor, the RSU signal indicating a status of a signal head perceived by the roadside unit; comparing, by the conflict monitor, the direct traffic controller signal to the RSU signal; and in response to the direct traffic controller signal being in conflict with the RSU signal, instructing, by the conflict monitor, the roadside unit to cease broadcasting a RSU broadcast signal.

In various implementations, the RSU broadcast signal is a signal phase and timing (SPaT) message.

In various implementations, the RSU signal is relayed to the IDSM from a radio receiver of the roadside unit.

Various implementations further comprise sending, by the IDSM and in response to the direct traffic controller signal being in conflict with the RSU signal, an alert to a traffic management center that is located remotely from the conflict monitor, wherein the alert indicates that the direct traffic controller signal is in conflict with the RSU signal.

Various implementations further comprise preventing data from flowing from the IDSM to the roadside unit.

Various implementations further comprise preventing data from flowing from the IDSM to the traffic controller.

Various implementations further comprise receiving, by the conflict monitor, a signal from a sensor, the sensor observing an actual status of the signal head.

In various implementations, the sensor is a camera capturing the actual status of the signal head.

Embodiments of the disclosure include a non-transitory computer-readable storage medium having instructions recorded thereon for monitoring signal conflicts in a traffic management system, wherein when the instructions are executed on a processing device, the instructions cause the processing device to perform operations including: receiving, from a traffic controller, a direct traffic controller signal, the direct traffic control signal indicating a status of a signal head perceived by the traffic controller; receiving, from a roadside unit, an RSU signal received by the roadside unit and relayed to the processing device, the RSU signal indicating a status of a signal head perceived by the roadside unit; comparing the direct traffic controller signal to the RSU signal; and in response to the direct traffic controller signal being in conflict with the RSU signal, instructing the roadside unit to cease broadcasting a RSU broadcast signal.

In various implementations, the instructions cause the processing device to receive the RSU signal as a signal relayed to the processing device from a radio receiver of the roadside unit.

In various implementations, the instructions cause the processing device to send, in response to the direct traffic controller signal being in conflict with the RSU signal, an alert to a traffic management center that is located remotely from the conflict monitor, wherein the alert indicates that the direct traffic controller signal is in conflict with the RSU signal.

In various implementations, the instructions cause the processing device to receive a signal from a sensor, the sensor observing an actual status of the signal head.

### DESCRIPTION OF THE DRAWINGS

The accompanying drawings, which are incorporated into and constitute a part of this specification, illustrate embodiments of the invention and together with the description, serve to explain the principles of the invention.

FIG. 1 is a block diagram showing an example of a conventional connected intersection system;

FIG. 2 is a block diagram showing an example of an improved connected intersection system in accordance with embodiments of the disclosure; and

FIG. 3 is a flow chart showing an exemplary method consistent with embodiments of the invention.

### DETAILED DESCRIPTION

Reference will now be made in detail to various implementations of the invention, examples of which are illustrated in the accompanying drawings. Wherever convenient, the same reference numbers will be used throughout the drawings to refer to the same or like parts.

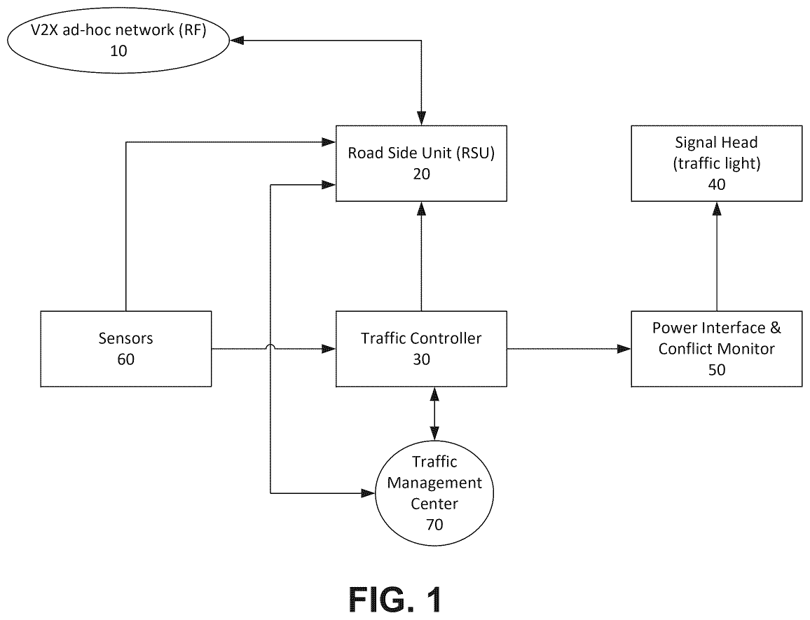

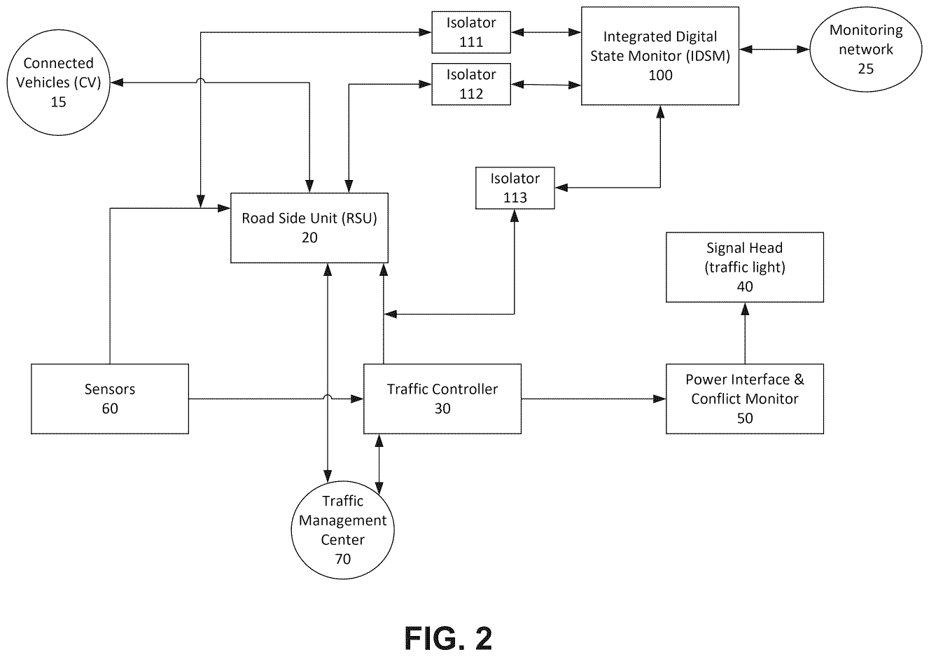

FIG. 1 shows an example of a conventional CI system. This exemplary CI system includes a traffic controller 30, a power interface and conflict monitor 50, a roadside unit (RSU) 20, a signal head (such as a traffic light, etc.) 40, and sensor(s) 60. In the example shown, the system communicates with a vehicle to everything (V2X) ad-hoc network 10 and with a traffic management center 70. The V2X ad-hoc network 10 includes connected vehicle(s), (e.g., CV 15 of FIG. 2), such V2X-enabled cars and trucks and the like, which may pass through an intersection that is controlled by the CI system. In this example, the RSU 20 contains the hardware and software needed to convert low-level traffic control protocols and signals into the properly formatted, compact, secure messages needed to communicate information to nearby CVs (e.g., V2X messages that comply with the relevant V2X standards). The RSU can typically also receive and interpret incoming messages from CV systems (typically from an On-Board Unit (OBU), e.g., an OBU mounted in a vehicle).

In FIG. 1, the conflict monitor 50 may be a Digital Conflict Monitor (DCM) that is a conventional device that monitors the activity of one or more traffic controller(s) 30 and receives broadcast messages from one or more RSU(s) 20. As shown, in some embodiments the DCM may be combined with, or part of, a power interface 50. The DCM interprets and compares the signals from the RSU(s) 20 and the signals from the traffic controller(s) 30 to determine whether the RSU(s) and traffic controller(s) are in agreement. For example, a RSU 20 may broadcast a Signal Phase and Timing (SPaT) message which contains information about the current state of each signal head 40 at a road intersection. In one example, an inconsistent or nonagreeing condition would occur if the SPaT message from the RSU 20 indicates that the current signal head state is “Green” when in fact the physical light at the signal head 40 was showing as “Red”. The SPaT message may also contain information the indicates when the next state change or phase change (e.g., color change) of the signal head (traffic light) 40 will occur—for example, information predicting when the signal head (traffic light) 40 will change from green to yellow and then to red.

A small amount or period of inconsistency or discrepancy between the SPaT message information regarding the current state of each signal head 40 and the actual physical state of the signal head 40, (on the order of, for example, less than 100 ms), may be deemed to be acceptable for most intersections, and he function of the DCM is to continuously measure and monitor these conditions and raise an alert if an unacceptable error state/condition, (e.g., a significant amount of error or discrepancy, such as greater than 100 ms), is detected. When an error condition is found, the DCM 50 typically instructs the RSU 20 to stop broadcasting and raises an alert at an authority such as, for example, the Traffic Management Center (TMC) 70 to request service for the CI system at the intersection.

While examples of embodiments of the disclosure described herein refer to a signal head 40 as being a traffic light, it is noted that in other embodiments the signal head 40 can be one or more of various other transportation-related devices and/or V2X environment devices, such as a roadside electronic text display, a lane merge signal, a train rail control, a lane control signal on a bridge or in a tunnel, or other transportation-related signal, display, or information-providing device.

FIG. 2. shows an example of an improved CI system in accordance with embodiments of the disclosure. In this example, a traffic controller 30 communicates with a power interface and conflict monitor 50 which communicates with a signal head 40, such as traffic light. One or more roadside unit(s) (RSUs) 20 communicate with the traffic controller 30. One or more sensor(s) (such as, for example, cameras) 60 communicate with the traffic controller 30. In embodiments, at least one of the sensors 60 is a digital camera that captures an image(s) of the actual state of the signal head. The RSU 20 communicates with one or more connected vehicle(s) CV 15 to relay information regarding the signal head to the CV 15. For example, the RSU 20 conveys the current state or status of the signal head 40 (for example, red, yellow, or green) to the CV 15, which is within a certain distance from the RSU 20. A traffic management center (TMC) 70 communicates with the traffic controller 30 and the RSU 20 to relay and receive information regarding the current state and/or future state of the signal head 40, such as, for example, a control signal to change the state of the signal head. In the example shown, the RSU 20 contains the hardware and software needed to convert low-level traffic control protocols and signals into the properly formatted, compact, secure V2X-compliant messages needed to communicate information to nearby CVs 15 and the like. The RSU 20 can typically also receive and interpret incoming messages from a CV 15, which are typically originated from an On-Board Unit (OBU) or OBU mounted in a vehicle. An integrated digital state monitor (IDSM) 100 receives communications (for example, signals) from the RSU(s) 20, the traffic controller 30, and/or the sensor(s) 60. In embodiments as shown, an isolator 111 is connected or positioned between the IDSM 100 and the sensor(s) 60 to prevent signals from being transmitted from the IDSM 100 to the sensor(s) 60. Similarly, an isolator 113 is connected or positioned between the IDSM 100 and the traffic controller 30 to prevent signals from being transmitted from the IDSM 100 to the traffic controller 30. In particular embodiments as shown, an isolator 112 is positioned between the IDSM 100 and the RSU(s) 20 to prevent signals from being transmitted from the IDSM 100 to the RSU(s) 20. In other embodiments (not shown), no isolator is positioned between the IDSM 100 and the RSU(s) 20 so that the IDSM 100 can send instructions to the RSU(s) 20, for example, instructions to cease transmissions (discussed below).

Thus, one exemplary difference between the IDSM 100 and conventional conflict monitor 50 is that the IDSM 100 can instruct, command, or otherwise interact with the RSU 20 so as to utilize or share specific functions of the RSU 20. This reduces the cost and complexity of the IDSM 100. In some specific embodiments, the IDSM 100 is configured to utilize the existing radio equipment within the RSU. In some other specific embodiments, the IDSM 100 is configured to utilize the RSU 20's external connections to the traffic controller, obviating the need for the isolator 113 and its associated communications lines and connections.

In the embodiment of FIG. 2, the IDSM 100 is connected to a monitoring network 25 that, in embodiments, monitors the IDSM 100 for alerts generated by the IDSM 100 in response to a problem in the CI system detected by the IDSM 100, such as an inconsistency, conflict, disagreement, error, or the like between the current state of the signal head 40 as reported and/or detected by the sensor 60 and as reported or communicated by the RSU 20. An inconsistency or conflict between the data and signals received and analyzed by the IDSM 100 can result from many causes, such as, for example, malicious activity, significant latency (e.g., the RSU 20 being too slow in broadcasting or relaying information regarding the state of the signal head 40), software glitches, hardware malfunctions, etc.

In embodiments, the IDSM 100 will observe the same information-containing signals from the traffic controller 30 as the RSU 20. In such embodiments, the IDSM 100 may independently monitor the information from these signals via the communications path through isolator 113. The IDSM 100 will also monitor the signals and information (e.g., V2X messages) being sent by the processor of the RSU 20 to its radio hardware for broadcast to the CV 15, (e.g., independently via the communications path through isolator 112). If an inconsistency or conflict exists between the signal head state indicated in the RSU's broadcast data and the current signal head state indicated by the traffic controller 30, then the IDSM 100 can instruct the RSU 20 to cease broadcasting the signal-head-state information (e.g., to stop sending SPaT messages). In some embodiments, the IDSM 100 can also send an alert to the TMC 70 to indicate the error state, so that the CI system can be examined and repaired as needed. By quickly halting the transmission of RF signals containing erroneous signal-head-state information from the RSU 20, the IDSM 100 prevents the CV 15 from relying on, (e.g., autonomously driving based on), the erroneous signal-head-state information, which may avoid property damage or worse. Damage or harm may occur, for example, in situations where the erroneous signal-head-state information indicates that the traffic light 40 is green, when it is in actuality red, which can result in vehicle collisions.

In some embodiments, the IDSM 100 operates independently of the functions performed by the RSU 20 and similar equipment. In such embodiments, the IDSM 100 performs a supervisory role, and the IDSM 100 is not directly impacted by the computational load or any software flaws that may exist in the RSU 20 and its processor. Correspondingly, in such embodiments, any problem with the operation of the IDSM 100, whether incidental or malicious, (e.g., a malevolent cybersecurity attack), has no or little impact on the operation of the RSU 20, the traffic controller 30, etc., due to the isolation of the IDSM 100 from the other components of the CI system.

More specifically, as shown in the embodiment of FIG. 2, the IDSM 100 may be implemented as an isolated computational platform with strict limits on the electrical interfaces between the IDSM 100, the RSU 20, the traffic controller 30 and the sensor 60. In embodiments, as mentioned above, electromagnetic or optical isolators (opt-isolators) 111, 112, 113 are used to ensure minimal interaction between these independent components. With this architecture, the IDSM 100 can safely observe, monitor, process, and evaluate the relevant input and output signals that are received, processed, and/or sent by, e.g., the RSU 20, while also ensuring that the IDSM 100 does not interfere with the RSU 20's normal operations and functions.

As described herein, various embodiments of the IDSM 100 compare or otherwise analyze the RSU 20's digital broadcast data with respect to the physical signal state in order to detect problems between the two, such as inconsistencies between the reported state of a signal head 40, whether permanent or temporary (e.g., due to latency). For safety reasons, among others, it is important that the V2X broadcast data matches the physical signal state.

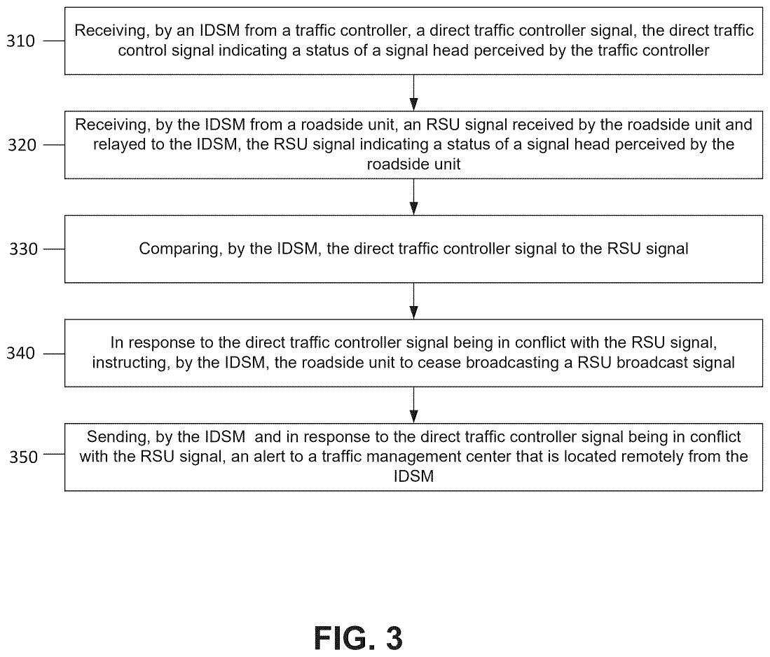

FIG. 3 shows an example of a method for monitoring the information reflecting the operation of a CI system, in accordance with embodiments of the disclosure. In FIG. 3, at step 310, a direct traffic controller signal is received by a IDSM (e.g., 100) from a traffic controller (e.g., 30), the direct traffic controller signal including information indicating the status of a signal head (e.g., 40) perceived by the traffic controller. At step 320, an RSU signal received by the roadside unit (e.g., 20) and relayed to or otherwise obtained by the IDSM (e.g., 100) is received by the IDSM from the roadside unit, the RSU signal indicating a status of a signal head as perceived by the roadside unit. At step 330, the IDSM compares the direct traffic controller signal to the RSU signal. In step 340, in response to the direct traffic controller signal being in conflict with the RSU signal as indicated by the output of the comparison at step 330, the IDSM instructs the roadside unit to cease broadcasting a RSU broadcast signal. In step 350, the IDSM sends, in response to the direct traffic controller signal being in conflict with the RSU signal, an alert to a traffic management center that is located remotely from the conflict monitor. In various implementations, step 350 is optional.

In general, the various methods, operations, steps, and functions described herein may be performed, at least partially, by one or more computers, computer systems, and/or virtual machines (VMs). In additional or alternative implementations, the various methods, operations, steps, and functions described herein may be performed, at least partially by one or more processors that are temporarily configured (e.g., by software) or permanently configured to perform the methods, operations, steps, and/or functions. Whether temporarily or permanently configured, such processors may constitute processor-implemented modules that operate to perform one or more methods, application operations, steps, functions, and roles described herein. As used herein, the term ‘processor-implemented module’ refers to a hardware module implemented using one or more processors.

Similarly, the processes, functions, steps, and operations described herein may be at least partially processor-implemented, with a particular processor or processors being an example of hardware. For example, at least some of the operations of a function may be performed by one or more processors or processor-implemented modules. Moreover, the processor(s) may also operate to support performance of the relevant operations in a ‘cloud computing’ environment or as a ‘software as a service’ (SaaS). For example, at least some of the operations may be performed by a group of computers (as examples of machines including processors), with these operations being accessible via a network (e.g., the Internet) and via one or more appropriate interfaces (e.g., an API).

The performance of certain of the steps, operations, etc. may be distributed among the processors, not only residing within a single machine, but deployed across a number of machines. In some example embodiments, the processors or processor-implemented modules may be located in a single geographic location (e.g., within an office environment, a manufacturing environment, or a server farm). In other example embodiments, the processors or processor-implemented modules may be distributed across a number of geographic locations.

Other embodiments of the invention will be apparent to those skilled in the art from consideration of the specification and practice of the invention disclosed herein. It is intended that this specification be considered as disclosing examples only, with a true scope and spirit of the invention being indicated by the forthcoming claims of the corresponding non-provisional application.

What is claimed is:

1. A system for monitoring signal conflicts in a traffic management system, comprising:
an integrated digital state monitor (IDSM) including a processor and a memory, the memory including computer-readable instructions that, when executed by the processor, cause the IDSM to perform operations comprising:
receiving, from a traffic controller, a direct traffic controller signal, the direct traffic control signal indicating a status of a signal head perceived by the traffic controller;
receiving, from a roadside unit, an RSU signal received by the roadside unit and relayed to the conflict monitor, the RSU signal indicating a status of a signal head perceived by the roadside unit;
comparing the direct traffic controller signal to the RSU signal; and
in response to the direct traffic controller signal being in conflict with the RSU signal, instructing the roadside unit to cease broadcasting a RSU broadcast signal.

2. The system of claim 1, wherein the RSU broadcast signal is a signal phase and timing (SPaT) message.

3. The system of claim 1, wherein the RSU signal is relayed to the IDSM from a radio receiver of the roadside unit.

4. The system of claim 1, further comprising computer-readable instructions that, when executed by the processor, cause the conflict monitor, in response to the direct traffic controller signal being in conflict with the RSU signal, to send an alert to a traffic management center that is located remotely from the conflict monitor,
wherein the alert indicates that the direct traffic controller signal is in conflict with the RSU signal.

5. The system of claim 1, further comprising an isolator between the IDSM and the roadside unit that prevents data from flowing from the IDSM to the roadside unit.

6. The system of claim 1, further comprising an isolator between the IDSM and the traffic controller that prevents data from flowing from the IDSM to the traffic controller.

7. The system of claim 1, further comprising computer-readable instructions that, when executed by the processor, cause the IDSM to
receive a signal from a sensor, the sensor observing an actual status of the signal head, and
compare the actual status of the signal head to the RSU signal.

8. The system of claim 7, wherein the sensor is a camera capturing the actual status of the signal head.

9. A method for monitoring signal conflicts in a traffic management system, the method comprising:
receiving, by an integrated digital state monitor (IDSM) from a traffic controller, a direct traffic controller signal, the direct traffic control signal indicating a status of a signal head perceived by the traffic controller;
receiving, by the IDSM from a roadside unit, an RSU signal received by the roadside unit and relayed to the conflict monitor, the RSU signal indicating a status of a signal head perceived by the roadside unit;
comparing, by the conflict monitor, the direct traffic controller signal to the RSU signal; and
in response to the direct traffic controller signal being in conflict with the RSU signal, instructing, by the conflict monitor, the roadside unit to cease broadcasting a RSU broadcast signal.

10. The method of claim 9, wherein the RSU broadcast signal is a signal phase and timing (SPaT) message.

11. The method of claim 9, wherein the RSU signal is relayed to the IDSM from a radio receiver of the roadside unit.

12. The method of claim 9, further comprising sending, by the IDSM and in response to the direct traffic controller signal being in conflict with the RSU signal, an alert to a traffic management center that is located remotely from the conflict monitor,
wherein the alert indicates that the direct traffic controller signal is in conflict with the RSU signal.

13. The method of claim 9, further comprising preventing data from flowing from the IDSM to the roadside unit.

14. The method of claim 9, further comprising preventing data from flowing from the IDSM to the traffic controller.

15. The method of claim 9, further comprising receiving, by the conflict monitor, a signal from a sensor, the sensor observing an actual status of the signal head.

16. The method of claim 15, wherein the sensor is a camera capturing the actual status of the signal head.

17. A non-transitory computer-readable storage medium having instructions recorded thereon for monitoring signal conflicts in a traffic management system, wherein when the instructions are executed on a processing device, the instructions cause the processing device to perform operations comprising:
receiving, from a traffic controller, a direct traffic controller signal, the direct traffic control signal indicating a status of a signal head perceived by the traffic controller;
receiving, from a roadside unit, an RSU signal received by the roadside unit and relayed to the processing device, the RSU signal indicating a status of a signal head perceived by the roadside unit;
comparing the direct traffic controller signal to the RSU signal; and
in response to the direct traffic controller signal being in conflict with the RSU signal, instructing the roadside unit to cease broadcasting a RSU broadcast signal.

18. The non-transitory computer-readable medium of claim 17, wherein the instructions cause the processing device to receive the RSU signal as a signal relayed to the processing device from a radio receiver of the roadside unit.

19. The non-transitory computer-readable medium of claim 17, wherein the instructions cause the processing device to send, in response to the direct traffic controller signal being in conflict with the RSU signal, an alert to a traffic management center that is located remotely from the conflict monitor,
wherein the alert indicates that the direct traffic controller signal is in conflict with the RSU signal.

20. The non-transitory computer-readable medium of claim 17, wherein the instructions cause the processing device to receive a signal from a sensor, the sensor observing an actual status of the signal head.
